(19) United States
(12) Patent Application Publication
(10) Pub. No.: US 2024/0281356 A1
(43) Pub. Date: Aug. 22, 2024

(54) COMPUTER-IMPLEMENTED SYSTEM AND METHOD FOR FLEXIBLY BENCHMARKING TRAINING PROGRAMS AND EXTRACTING INSIGHTS

(71) Applicant: Skilljar, Inc., Seattle, WA (US)

(72) Inventors: Niran Kundapur, Seattle, WA (US); Sandi Lin, Seattle, WA (US); Jason Stewart, Seattle, WA (US)

(73) Assignee: Skilljar, Inc., Seattle, WA (US)

(21) Appl. No.: 18/427,700

(22) Filed: Jan. 30, 2024

Related U.S. Application Data
(60) Provisional application No. 63/447,427, filed on Feb. 22, 2023.

(51) Int. Cl. G06F 11/34

(52) U.S. Cl. CPC G06F 11/3428; G06F 11/3438; G06F 11/3447

(57) ABSTRACT

Training programs (e.g., for training a user to use a company's products) may be flexibly benchmarked by first identifying user interactions with one or more of the training programs and converting the user interactions into user activity data objects associated with user identifiers. The user activity data may then be made anonymous by removing the user identifiers from the data before examining the data. The anonymized user activity data may then be aggregated with respect to each of the training programs. A benchmark model for evaluating the training programs may then be determined based on a flexible benchmark schema of selectable benchmark metrics for evaluating aspects of the training programs. Benchmarks may then be calculated for each of the training programs based on the aggregated user activity data and the benchmark model. The benchmarks may then be displayed and/or analyzed to generate insights or suggestions for improving the training programs.

### CROSS-REFERENCE TO RELATED APPLICATION

This application claims benefits of U.S. Provisional Application No. 63/447,427 filed on Feb. 22, 2023, which is incorporated by reference in its entirety.

### TECHNICAL FIELD

The present disclosure relates to a system and method that can flexibly benchmark training programs and extract insights thereof. Implementations of the disclosure may compare performance metrics and practices associated with comparing a company's training programs to industry standards and best practices from other similar companies (e.g., benchmarking), and may use a computer-implemented system to flexibly benchmark training programs according to user-defined criteria and to extract insights from the associated benchmarking data.

### BACKGROUND

A company/business may produce sophisticated technological products (e.g., software applications) that may require a user to be trained in order to properly use the products. The effectiveness of such user training may directly impact the sales volume and/or customer satisfaction associated with the business and therefore the financial performance of the business. For example, a business may need to generate revenue (and/or other financial metrics) to continue operating efficiently. The business may generate revenue when they fulfill their customers' needs with their products, and improve or maintain their profit margin when they can grow their customer base without correspondingly increasing the need to provide more customer support services (e.g., to users who are not sufficiently trained to use the sophisticated products of the business). Accordingly, the financial metrics of the business may be negatively impacted if their users/customers are not properly trained to use the sophisticated products of the business.

The ever-increasing pace with which businesses produce and innovate products may require a business to have a training program manager who manages different training programs associated with these products in order to help busy professional users gain the skills and/or knowledge required to effectively use the products. For example, businesses may establish training academies to train the users/customers of these products and may employ training program managers to operate these academies. However, it may be difficult for a business to determine the quality of their training programs are high-quality training programs (e.g., compared to other similar training programs in the same industry) and to determine how to continually improve their training programs over time.

Furthermore, businesses may also employ curriculum developers to create training content for use in their academies to train users. These curriculum developers may face problems similar to those described above with respect to training program managers at more granular levels. For example, it may be difficult for the curriculum developers to determine the effectiveness of an overall curriculum, courses in the curriculum, bundles of courses (bundled into “learning paths”), lessons in the courses, the modality, length, organization, bundling of the lessons etc.

### BRIEF DESCRIPTION OF THE DRAWINGS

The present disclosure is illustrated by way of example, and not by way of limitation, in the figures of the accompanying drawings.

FIG. 1 illustrates a computing system implementing a flexible benchmark application for evaluating training programs, according to implementations of the disclosure.

FIG. 2 shows a block diagram of a user activity data object used to store data regarding user interactions with the training programs, according to implementations of the disclosure.

FIG. 3 shows a block diagram of a benchmark data object used to store data associated with benchmark values for the training programs, according to implementations of the disclosure.

FIG. 4 shows a block diagram of a graphical user interface (GUI) for interacting with the benchmarks used for evaluating the training programs, according to implementations of the present disclosure.

FIG. 5 shows a block diagram of a GUI for selecting best accounts for comparison to other accounts regarding benchmark metrics, according to implementations of the present disclosure.

FIG. 6 shows a block diagram of a GUI for examining insights and/or suggestions, from an AI, for improving the training programs, according to implementations of the disclosure.

FIG. 7 shows a flow diagram illustrating a method that uses a machine learning (ML) model trained to generate insights and/or suggestions for improving the training programs, according to implementations of the present disclosure.

FIG. 8 shows a flow diagram of a method for implementing a flexible benchmark application for evaluating training programs, according to implementations of the disclosure.

FIG. 9A shows a flow diagram of a method for using a machine learning (ML) model to provide suggested features for a training program based on a comparison of training program features, according to implementations of the disclosure.

FIG. 9B shows a flow diagram of a method for updating values for the benchmarks displayed in the GUI based on additional aggregated data associated with user interactions with a training program, according to implementations of the disclosure.

FIG. 10 shows a block diagram illustrating a machine, in the example form of a computer system, within which a set or sequence of instructions may be executed to cause the machine to perform any one of the methodologies discussed herein.

### DETAILED DESCRIPTION

Although product training may be an important part of a business operation, there may be very little data available to the business regarding actionable insights that training program managers and/or curriculum developers may use to systematically evaluate and/or improve training programs for the users of products sold by the business. The evaluation and/or improvement of training programs may pose significant challenges for a business. For example, the business may not have access to any data regarding the training programs of other businesses, no trusted way to exchange data with other businesses, no standardized data structures for capturing learning content and activity data at scale, no system to benchmark the performance of the training programs, no system to maintain these benchmarks or add new relevant benchmarks, and no system to make these benchmarks available to training program managers and curriculum developers (e.g., via a browser application).

Solutions to some of the above-noted challenges associated with evaluating and/or improving training programs may include those trying to eliminate the need for training programs altogether. For example, a business may strive to produce intuitive products that may be learned quickly by a user during the user's initial use of the product. However, this approach may be ineffective with respect to products that become more complex over time as more features are added or with respect to product users that have such a variety of product use cases and product usage contexts that they need to be trained in order to best extract value from the product in each case/context. Furthermore, a business may include embedded training plug-ins in their products in order to provide tours of product features in their products. However, even if these feature tours may help the user obtain an initial overview of an unfamiliar product or feature, they may not be sufficient if the users do not take advantage of the tours or if the tours cannot provide in-depth and systematic training for specific product use cases or usage contexts.

Further solutions to some of the above-noted challenges associated with evaluating and/or improving training programs may include those using published reports and podcasts to capture best practices through focus group research and/or expert interviews. While these solutions may be good sources of qualitative information, they may not have a large enough sample size of data and/or they may not connect the training results to business outcomes. A massive open online course (MOOC) may be focused on consumers rather than professional users. A MOOC may be operated by a third party (e.g., separate from the business and the user) and therefore it may be insufficient in evaluating training program effectiveness because the businesses loses control of their own customers' experience to the MOOC's standardized experience, resulting in that the business does not obtain the in-depth data needed to evaluate or improve training programs and that the training program managers and curriculum developers do not have creative control of their training content. Also, users who need training on less popular products/topics may be under-served because MOOCs focus on more popular products/topics. Live training and 1-1 coaching may include instructors or coaches teaching in a live setting, either in person or via videoconference. However, these may be insufficient for evaluating training program effectiveness because some users may not be able to participate in this modality or the training session and data may not always be recorded for later viewing/listening.

Though training services and learning management systems (LMS) have been available for decades, training customers on-demand and in virtual environments and in a variety of modalities is still relatively new. This new training environment is often referred to as “Customer Education” and because it is a new industry, there is insufficient data, insights, and expertise for businesses, training program managers, and curriculum developers to leverage for improving training programs and driving associated business outcomes.

In order to overcome the above-identified and other deficiencies associated with evaluating and/or improving the training programs of a business, implementations of the present disclosure provide computer-implemented systems and methods for flexibly benchmarking training programs for target users of products of the business (e.g., professionals who use the products). Implementations may generate reports of quantitative benchmark scores regarding the effectiveness of these training programs to provide insights about these training programs to training program managers and curriculum developers, who may rely upon these reports to select and improve the training programs.

Implementations of the disclosure may provide training program managers and curriculum developers with timely, relevant, easily accessible, always available, trustworthy, and detailed information on the performance of a high-quality benchmark training program and insights into how they can improve their own programs to drive professional learning and business impact.

For example, unlike solutions that may attempt to eliminate the need for training, the solution described herein builds on the proven value of training in building useful job-relevant skills among busy professionals in a world of ever-increasing technological changes.

Furthermore, unlike solutions that include training or are related to training, the solution described herein is built on a large unique granular dataset of activities of professionals who learned voluntarily to gain useful in-demand skills of varying popularity.

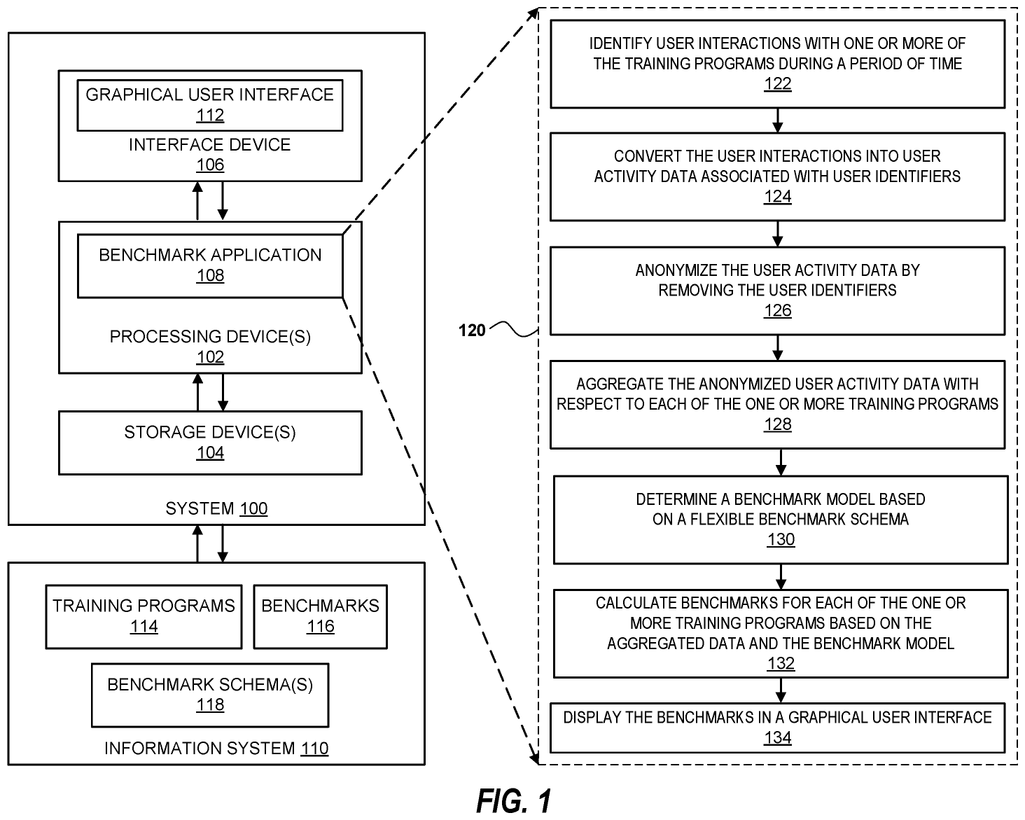

FIG. 1 illustrates a computing system 100 implementing a flexible benchmark application 108 for evaluating training programs according to implementations of the disclosure.

Referring to FIG. 1, computing system 100 may include one or more processing devices 102, a storage device 104, and an interface device 106, where the storage device 104 and the interface device 106 may be communicatively coupled to processing devices 102.

Processing device 102 may be a hardware processor such as a central processing unit (CPU), a graphic processing unit (GPU), or an accelerator circuit. The interface device 106 may be a display device such as a screen of a desktop, laptop, or smartphone. The storage device 104 may be a memory device, a hard disc, or a cloud storage device connected to processing device 102 through a network interface card (not shown).

The processing device 102 may be a programmable device that may be programmed to implement a graphical user interface 112 presented on interface device 106. Graphical user interface (“GUI”) 112 may allow a user (e.g., a training program manager or a curriculum developer) to view graphic representations (e.g., regarding training benchmarks) presented on interface device 106, and may also allow the user to interact with graphic representations (e.g., icons) presented on GUI 112 with an input device (e.g., a keyboard, a mouse, and/or a touch screen). In some implementations, GUI 112 may include graphical representations such as charts, spreadsheets, graphs, etc. associated with the benchmark scores of different training programs.

Computing system 100 may be connected to (at least one) other information system 110 through a network (not shown). The information system 110 may include databases that contain information relating to user training programs. For example, information system 110 may store training programs 114 (e.g., video/audio/multimedia contents of training lessons) that may be presented to a target user through content players (e.g., audio player, video player). Furthermore, information system 110 may store benchmark scores 116 associated with the training programs. A specific benchmark score 116 associated with a specific training program 114 may indicate the effectiveness of the training program in training a target user. The information system 110 may also store a benchmark schema 118 of metrics for evaluating the training programs. In one implementation, the metrics included in the benchmark schema 118 may be defined by a user so that flexible benchmarking of the training programs 114 is possible.

Processing device 102 may execute a flexible benchmark application 108 to implement a method 120 that may calculate the benchmark scores 116 for the training programs 114 based on historic and/or real-time user interactions with the training programs 114. The system 100 may provide access to the benchmark application 108 via a web app so that a user may interact with the benchmark application 108 at any time.

The method 120 may include, at 122, processing device 102 may identify user interactions with one or more of the training programs 114 during a period of time. The training programs 114 may include discrete and/or self-contained training materials for one or more products of the business. For example, information system 110 may store different types of training programs 114 such as, for example, online text-based courses (e.g., web pages), video courses (e.g., segments of classroom or computer screen recordings), audio courses (e.g., podcasts, classroom recordings), and/or multimedia courses (e.g., interactive online lessons). The training programs 114 may also include different modalities of training, such as on-demand, live event, lab, or examination. For each product, the business may prepare multiple training programs 114 of one or more types and modalities. The training programs 114 for a particular product may include identical contents (e.g., the same training lesson presented in text, video, or audio format). Alternatively, the training programs 114 for the same product may include different content (e.g., different edits of the same training lesson, different presentations, or different trainers) directed to training for the same product. Additionally, the business may classify the products and their corresponding training programs 114 into groups of a similar nature that may be trained in similar manners. For example, training programs may be classified into groups based their audience size or by the ages of their programs (where the age of a program represents the time from the deployment to the current time). Each group may be associated with a type and/or modality of the training programs 114.

In one implementation, a training program 114 may include timestamps aligned with its content, thus enabling the determination of precise start and end times of each session of training by a user so that the resulting user activity data may be determined to be within the period of time for which benchmarks are being calculated. Each training program 114 may further include metadata associated with information, such as, whether the training is mandatory or optional, target industries, target audience, recommended start time, the user's competence level (e.g., prerequisite trainings and/or skill levels) expected by the training program 114, expected time to complete the training program 114, and checkpoints (e.g., quiz questions and answers for the user) to assess the success of the training program 114. These types of metadata may be useful in determining the effectiveness of the training program 114.

The identification of user interactions with the training programs 114 stored in information system 110 may include verification of the user's identifier and credentials (e.g., user login handle and password) to check out a training program 114 and presentations of the training program 114 to the user, where user interactions may include a start, a pause, a replay, a click on a hyperlink, an annotation, and an end of a session of the training program 114 by a media player on the GUI 112.

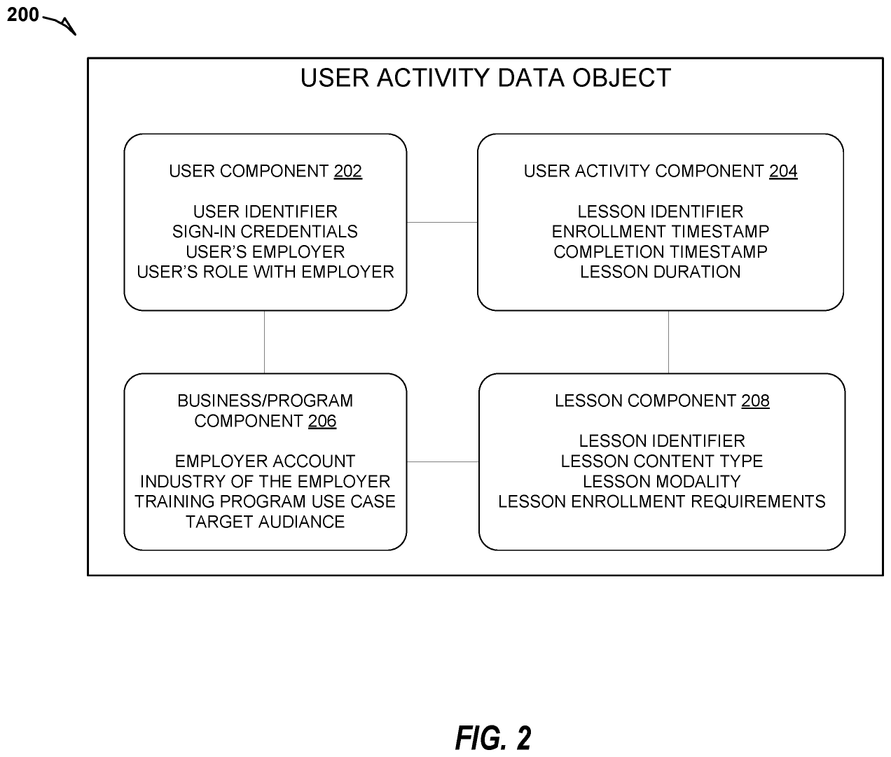

Responsive to identifying user interactions with one or more training programs 114 using GUI 112, at 124, processing device 102 may convert the user interactions into user activity data associated with user identifiers (e.g., in the form of user activity data objects described more fully below with respect to FIG. 2) and record them in storage device 104 (or in information system 110). In one implementation, the user activity data object may be defined according to a data structure format for recording the user activities during training sessions or user interactions with training programs. A user activity data object may include one or more components each further including one or more pre-defined data entries representing different attributes. The components may include user information, user activity information, business and program information, and lesson information. The data entries may capture different attributes of the user activities that may be useful for benchmarking the effectiveness of the training program for the corresponding product. For example, the data entries may include a user identifier that is associated with a target user, an employer identifier that is associated with an end user company that employs the target user, a training academy identifier that is associated with the training provider, and/or real-time user activity data captured during the training. The real-time user activity data may further include lesson identifiers associated with different lessons in the training program, the timestamp of enrollment of a training program and the timestamp of completion of the training program if completed, timestamps of beginning different sessions and timestamps of completing different sessions if completed, the duration of session times etc.

Referring to FIG. 1, to maintain the confidentiality and privacy of different businesses and users, flexible benchmark application 108 may remove business and user identification information before using the user activity data to calculate benchmark scores of different training programs. At 126, processing device 102 may anonymize the user activity data by removing or masking any user identification information and/or business identification information (e.g., the user identifiers). In one implementation, processing device 102 may anonymize the user activity data by removing information that identifies the user of the training program or identifies the training program. For example, one way to anonymize the user activity data is to replace the username and training program identifiers with hashed identifiers which may be globally unique identifiers, to preserve the privacy of the user and the training program. A business' training program information may be anonymized to maintain the confidential and privileged information regarding (a) the business, (b) the combinations of methods and modalities developed by the business in its training programs, and (c) the performance of the business' training programs measured directly in terms of a user's usage of the training programs, or indirectly in terms of a user's usage of the business' products (which may be a proxy for the business's performance). Therefore, a business may not know which other business's training program data is included in the calculation of the benchmark values. Furthermore, a business may not know for certain which benchmark values its own training program data is included in because the benchmarks may be produced using only a sampling of programs across businesses, or a sampling of programs of a given business. A given training program may be removed from benchmark calculations for various reasons, such as, it may face an abrupt change (e.g. the business converts a paid program into a free program or vice versa), or it may face abrupt temporal effects (e.g. the business runs a promotion to drive users to the program, or an upcoming deadline such as a professional certification for new tax laws), or it may need to be removed in order to minimize the chances of the human user of the benchmarks consciously or unconsciously biasing their interpretation of the benchmarks in a manner similar to the objective of double-blind clinical trials.

Based on the anonymized user activity data, flexible benchmark application 108 may further proceed according to method 120. At 128, processing device 102 may aggregate the anonymized user activity data with respect to each of the one or more training programs. The aggregation may allow for the calculation of the statistics indicating the effectiveness of each of the training programs (e.g., benchmarking). After the aggregation, the anonymized user activity data may be associated with a corresponding training program.

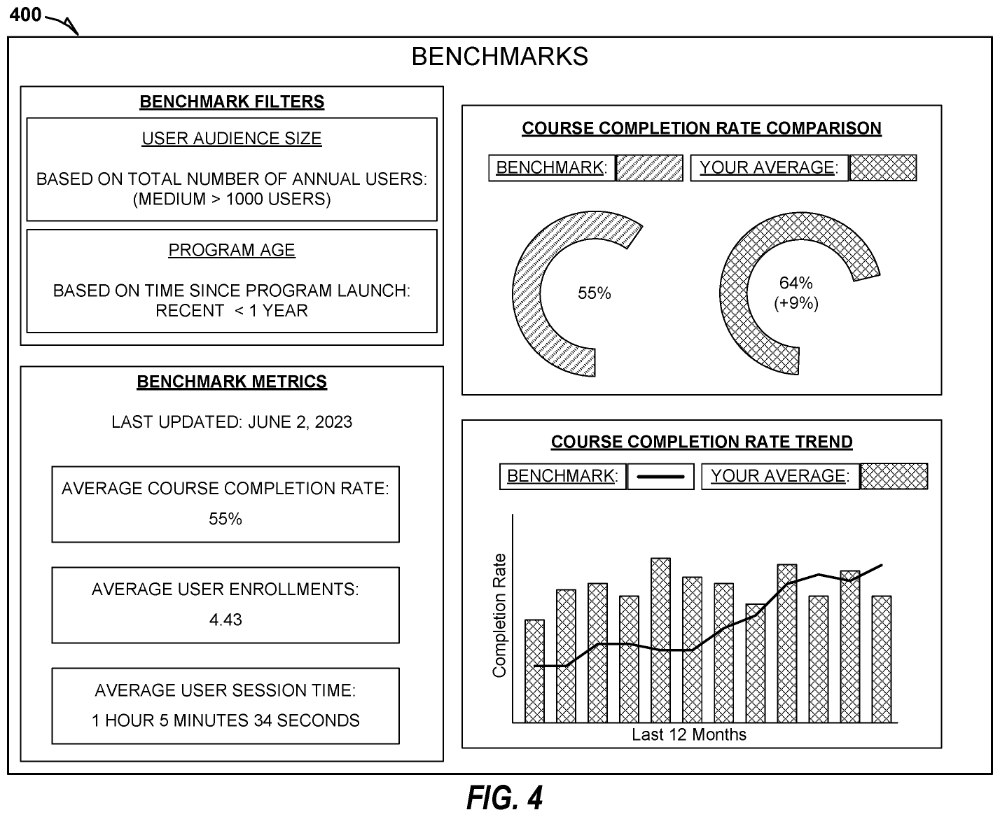

At 130, processing device 102 may determine a benchmark model based on a flexible benchmark schema that can be configured by a system manager or user, thus allowing flexible and custom benchmarks without reprogramming the benchmark application 108. For example, the benchmark schema may include a variety of benchmark metrics, such as average completion rate of program users, enrollments per program user and session time per program user, that may be selected to form the benchmark model for evaluating the training program. As noted above, in one implementation, the metrics included in the benchmark schema 118 may be defined by a user (see FIG. 4 below) so that a more flexible benchmarking of the training programs 114 may be possible.

For example, there may be a global schema for benchmark metrics as shown in table 1 below:

TABLE 1

| NAME | TYPE | COMMENTS |
|---|---|---|
| HOURS_PER_USER | FLOATING POINT | The total number of hours learned |
| | | divided by the number of active users |
| BENCHMARK_TYPE | STRING | Selection from global, user_audience, |
| | | or program_age |
| BENCHMARK_SELECTION | INTEGER | Expects either 1, 2, or 3 depending on |
| | | benchmark_type |
| CALCULATED_AT | TIMESTAMP | If benchmark_type is global, then this |
| | | is set to 1. For user_audience or |
| | | program_age benchmark_types, it |
| | | may be mapped as follows: |
| | | user_audiance “small” or program age |
| | | “recent”: 1; |
| | | user_audiance “medium” or program |
| | | age “older”: 2; |
| | | user_audiance “large” or program age |
| | | “oldest”: 3 |

Furthermore, there may be a user-specific schema for benchmark metrics as shown in table 2 below:

TABLE 2

| NAME | TYPE | COMMENTS |
|---|---|---|
| MONTHS_START_AT | DATE FIELD | Same definition as in the Benchmarks |
| | | schema |
| TOTAL_COMPLETIONS | INTEGER | The number of completed enrollments |
| | | in that monthly time period |
| TOTAL_ENROLLMENTS | INTEGER | The number of enrollments, both |
| | | completed and not yet completed, in |
| | | that monthly time period |
| TOTAL_SECONDS | INTEGER | To calculate the total number of hours |
| | | learned |
| ORGANIZATION | FOREIGN KEY | The company that the user belongs to. |
| UPDATED_AT | TIMESTAMP | When the row was updated |
| CREATED_AT | TIMESTAMP | When the row was created |
| NUMBER_USERS | INTEGER | Number of active users |
| COURSE | FOREIGN KEY | The course the user is enrolled in |
| DOMAIN | FOREIGN KEY | The domain of the learning portal. A |
| | | user may have multiple domains, e.g., |
| | | for external/internal audiences |

At 132, processing device 102 may calculate benchmark scores for each training program based on the aggregated anonymized user activity data and the benchmark model. The training programs may be evaluated based on the benchmark metrics selected from the flexible benchmark schema to generate the benchmark model. In some implementations, the benchmark calculation may include applying “benchmark program criteria”, generating a large number of “candidate benchmarks”, applying “benchmark selection” criteria, performing “aggregation by criteria” and calculating “benchmark metrics and trends” as described below.

The processing device may aggregate the anonymized user activity data with respect to each of the one or more training programs based on the respective training program satisfying specified benchmark program criteria. As noted above, the specified benchmark program criteria may include at least one of a number of users of the program during the period of time and an age of the program at the end of the period of time. For example, the audience size in terms of the number of users may have to meet a sample size threshold, for example, less than 1000, between 1000 and 10,000, and over 10,000 annual learners, which may be referred to as small, medium, or large programs, respectively. Another example may be the age of the training program. Several criteria may be combined, for example, a large professional user audience, in the first year of launch, and for a certification use case. The combination of different criteria can be an “AND” or “OR” relation. User activity data generated by user interactions with each of the one or more training programs that satisfies the specified benchmark program criteria may then be aggregated according to each of the one or more training programs.

Training program metrics may then be calculated based on the above aggregated user activity dataset per training program. The training program metrics may include, for example, lesson completion rate for program A, for program B, and so on. An algorithm may be employed to clean the training program metric data before it may be used for the determination of any benchmark metrics. In one implementation, the cleaning algorithm may be the median of the training program metrics of the individual training programs, so that any program with an outlier metric does not over-influence the benchmark metric. For example, any aggregated user activity data from interactions with a training program that has a value for a training program metric that is greater than a threshold value from the median of the values for the training program metric for the other training programs may be removed before benchmark metrics are determined. Any trends in the benchmark metrics may be calculated periodically as described further below.

A set of candidate benchmarks may then be produced based on the training program metrics. Then certain candidate metrics may be calculated based on these candidate benchmarks, such as the number of unique training programs that constitute the candidate benchmark. From among the candidate benchmarks, the viable benchmarks may be selected based on specific benchmark selection criteria such as sample size of programs (e.g. minimum number of unique programs underlying the benchmark), feasibility of breaking out the benchmark into more fine-grained benchmarks (e.g. program age benchmark can be broken out into early, mid-tenure, and mature programs), sample size and variance of user activity data within the programs (e.g. outlier programs are removed), usefulness to other similar programs (e.g. on-demand videos & text and virtual live training may be very popular while audio-based training may be less popular).

At 134, processing device 102 may present the calculated benchmark values in a graphical user interface (GUI) such as GUI 112 of interface device 106. The calculated benchmark metrics may then be loaded into production databases so that they may be made available on-demand to the users (e.g., a training program manager or a curriculum developer) of the benchmark application 108. When new benchmark metrics become available (e.g., from a subsequent period of time) they may be displayed in the GUI 112 as described below, so that the benchmark application 108 may smoothly transition from an older benchmark metrics dataset to a newer benchmark metrics dataset.

As noted above, updates to the benchmark scores of the training programs may be performed on a periodic basis, for example monthly, after the full month of user activity data associated with the training program is available. The update to the benchmark scores of the training programs may include a full recalculation of the benchmark scores. Each training program may be re-evaluated with regard to whether it satisfies the benchmark program criteria, as described above, before new user activity data associated with the training program is used for the calculation of benchmarks. This may ensure that the updated benchmarks are based only on user activity data associated with training programs that currently satisfy the benchmark program criteria, and exclude any programs that do not currently satisfy the benchmark program criteria.

FIG. 2 shows a block diagram of a user activity data object 200 used to store data regarding user interactions with the training programs, according to implementations of the disclosure. User activity data object 200 may include a user component 202, a user activity component 204, a business and program component 206, and a lesson component 208. Each component may further include attribute values that further specify the corresponding component. In one implementation, as shown in FIG. 2, the user component 202 may further include attributes and their corresponding attribute values of: user's name or identifier, user's sign-in credentials, user's employer, and user's role in the employer's organization. The user activity component 204 may include attributes and their corresponding attribute values of: identifiers for the user and the lesson taken, timestamps for enrollment and completion of the lesson, enrollment durations and session durations (for those incomplete sessions), user group, academy, program, and business, etc. Business and program component 206 may include attributes and their corresponding attribute values of: industries of the business (e.g., software, healthcare, or finance), use case of the training program (e.g., onboarding, certification), target audience (e.g., customer, business partner, employee), academy, training program effective dates (start date, valid dates), and the customer accounts (employers of users). Lesson component 208 may include attributes and their corresponding attribute values of: title or identifier of a lesson, lesson content type (e.g., video, text, audio, sharable content object reference model (SCORM)), lesson modality (e.g., on-demand, live event, lab, examination), lesson requirement (e.g., mandatory or optional), courses in the lesson (e.g., logically organized contents of the lesson) etc. Processing device 102 may capture activity data object 200 in real time while the user takes lessons from the training program.

In one implementation, user activity data objects 200 with respect to different training programs may be recorded with timestamps as a learner uses a business's academy site (e.g., accessing the site and signs up or logs in, views various pages within it, registers for courses, and completes them or abandons them, to name a few activities). Such user activity data may be recorded at the level of detail of the user, the business, the academy site, the page or course or other learning content. In practice, a large amount of training programs may be developed by curriculum developers and managed by training program managers through a centralized training portal. The centralized training portal may be implemented in computer system 100 and may collect and calculate benchmark scores for different training programs associated with the different products of diverse businesses. As noted above, the benchmark scores may be calculated and then periodically updated. The results of the calculation may be stored in a benchmark data object described below.

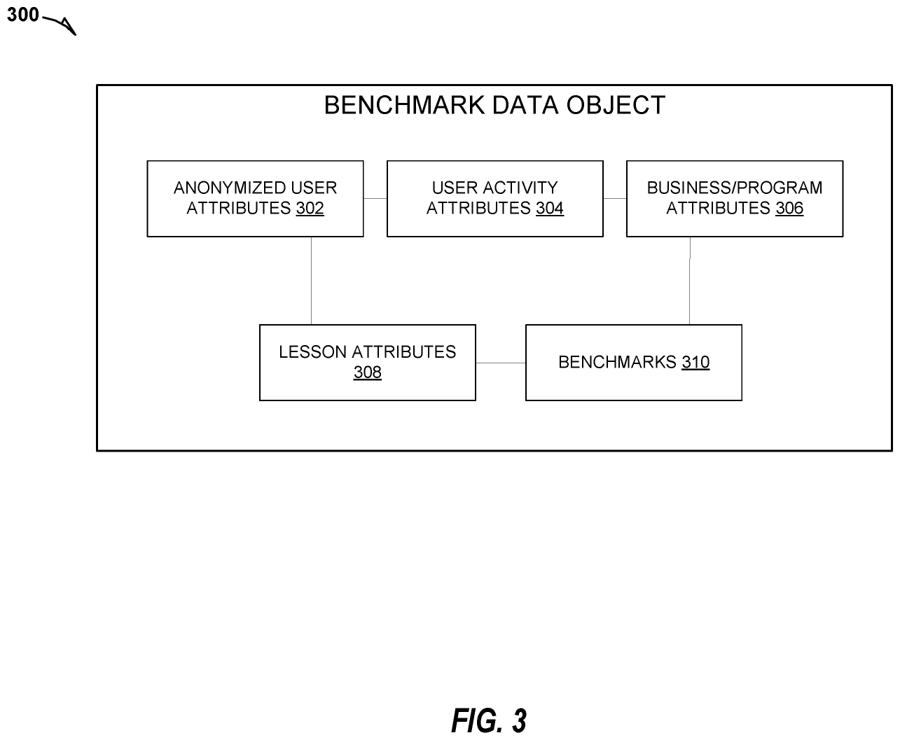

FIG. 3 shows a block diagram of a benchmark data object 300 used to store data associated with benchmark values for the training programs, according to implementations of the disclosure. As shown in FIG. 3, benchmark data object 300 may include anonymized learner attributes 302 (derived from user component 202 by anonymization), user activity attributes 304 (e.g., based on user activity component 204), business and program attributes 306 (e.g., based on business and program component 206), lesson attributes 308 (e.g., based on lesson component 208), and the calculated benchmark scores 310. These attributes 302-308 and the benchmarks 310 may be associated with a specific training program.

In one implementation, computer system 100 may provide a secure access function, thus the system may be protected from unauthorized use by a system of roles, permissions, and access control throughout the system 100. Computer system 100 may also allow a business to opt out the benchmarking process. A business may choose to opt-out of making its anonymized training program activity data available for benchmarking. In one implementation, a business that chooses to opt-out of making its anonymized training program activity data available for benchmarking may also lose the access to insights provided by the benchmark system.

Computer system 100 may provide a frontend user interface (e.g., displayed on GUI 112 of interface device 106) for a system user (e.g., a training program manager or a curriculum developer) to access the benchmarks of training programs in order to assess the effectiveness of these programs. In some implementations, the frontend user interface may provide one or more of the following options and/or functionalities.

A user (e.g., the training program manager or the curriculum developer) may log into their admin dashboard of the frontend user interface via username/password or single sign-on (SSO). If it is the first time the user is signing in, the system may create an account for them.

From a navigation menu of the frontend user interface (e.g., on one side of the frontend user interface), the user may access a “benchmarks page” (which may be located under an analytics section). The benchmarks page may also be directly accessed and bookmarked for future use.

FIG. 4 shows a block diagram of a graphical user interface (GUI) for a user to interact with the benchmarks (e.g., the benchmarks page 400) used for evaluating the training programs (e.g., the benchmarks page), according to implementations of the present disclosure.

The benchmarks page 400 may include interface elements for examining relevant benchmarks, for example, the user may assess how their training programs stack up against other training programs similar to theirs. The user may examine the relevant benchmarks by selecting “benchmark filters” and/or “benchmark metrics” that are most relevant to their training programs. For example, the selection of benchmark filters may allow the user to limit the benchmarks by “user audience size” based on a total number of users during a selected time period (e.g., one year) with a “medium” audience size being less than 1000 users and/or by a “program age” based on the time since the training program was launched with a “recent” age being less than one year.

Furthermore, the selection of benchmark metrics (since the last periodic update as described above) may allow the user to limit the benchmarks by “average course completion rate” based on a total number of users completing a course during a selected time period (e.g., one year) and/or by “average user enrollments” based on a total number of enrolled users during the selected time period and/or by “average user session time” based on a total amount of session per user during the selected time period.

In some implementations, additional benchmark filters/metrics may also be available for examining the benchmark data. For example, a selection of benchmark filters/metrics may limit the benchmark data to data based on training programs created by mid-sized software companies with monetized on-demand training for their customers in the first year of launch. Another example may be a selection of benchmark filters/metrics that limits the benchmark data to data based on training programs created by large financial services companies in North America for their broker partners delivered via virtual instructor-led training and certifications.

The benchmarks page 400 may also provide interface elements for comparing its key training program metrics with other similar programs that are aggregated by the benchmark application. For example, based on the selected benchmark metrics being “average completion rate”, “enrollments per user” and session time per user”, a “course completion rate comparison” interface element may allow the user to examine the course completion rate of their training program in comparison to the benchmarks (e.g., 64% vs. 55% for a +9 completion rate vs the benchmark value). Furthermore, a “course completion rate trend” interface element may allow the user to view any trends regarding their own program's completion rate values vs the trend in the benchmark completion rate values. The distribution of the completion rate values of the training program vs. the benchmark over the selected time period (e.g., one year) may be displayed as a graph representing each set of completion rate values over the selected time period.

In some implementations, the user may group their programs and curriculums (lessons, courses, learning paths, catalog pages) within the programs at various levels. For example, the user may group lessons based on modality such as video, text/html, audio, virtual live training, embedded files, labs, exams. Furthermore, courses and lessons may be grouped and labeled according to the topic, skill, primary language, and in other custom ways. Training programs may also be grouped based on the audience e.g., programs for customers, or for business partners, or for employees. These program classifications may be used to create benchmarks, for example, a benchmark for virtual instructor-led training and certifications with a certain annual learner audience size threshold value.

In some implementations, the user may group their users into user groups, for example, a group of all the users from a same company called Acme. In this example, Acme may be a customer account or business partner account of the business that employs the user. The user groups may be used to create benchmarks, for example, a benchmark for on-demand learning at the best accounts across several programs. From a navigation menu of the frontend user interface, the user may access a “best accounts” page (which may be located under an analytics section). The best accounts page may also be directly accessed and bookmarked for future use.

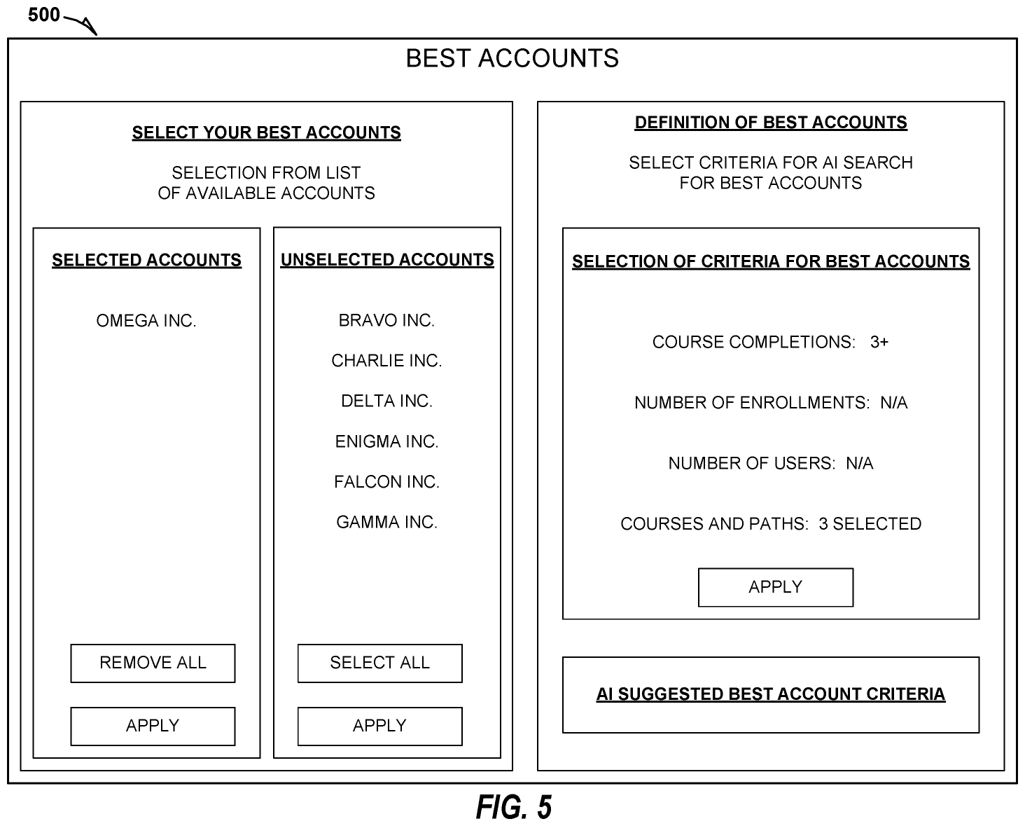

FIG. 5 a block diagram of a GUI for selecting best accounts for comparison to other accounts regarding benchmark metrics (e.g., the best accounts page 500), according to implementations of the present disclosure.

The best accounts page 500 may include interface elements for selecting a program manager's best training program user groups or accounts (e.g., users from a particular customer that has taken training in a centralized training portal associated with the different products of a business). For example, the user may directly select their best accounts by using the “select your best accounts” interface element which may provide “selected accounts” and “unselected accounts” interface elements for selecting, unselecting and viewing available user accounts of the program manager (e.g., Omega Inc. is the only selected account in FIG. 5). The “select your best accounts” interface elements allow the program manager to easily select accounts and may also save the selected accounts as the program manager's best accounts.

Furthermore, the user may alternatively or additionally define criteria for indirectly selecting their best accounts by using the “definition of best accounts” interface element which may provide “selection of criteria for best accounts” and “artificial intelligence (AI)-suggested best accounts” interface elements for directly selecting the best account criteria (e.g., number of course completions, number of enrollments, etc.), or for having an AI suggest the best account criteria and manually adjusting the AI-suggested criteria if the program manager disagrees with the suggested criteria. For example, the AI may suggest that a best account be defined as an account that has 3 or more completions of an “Essentials Certification” course.

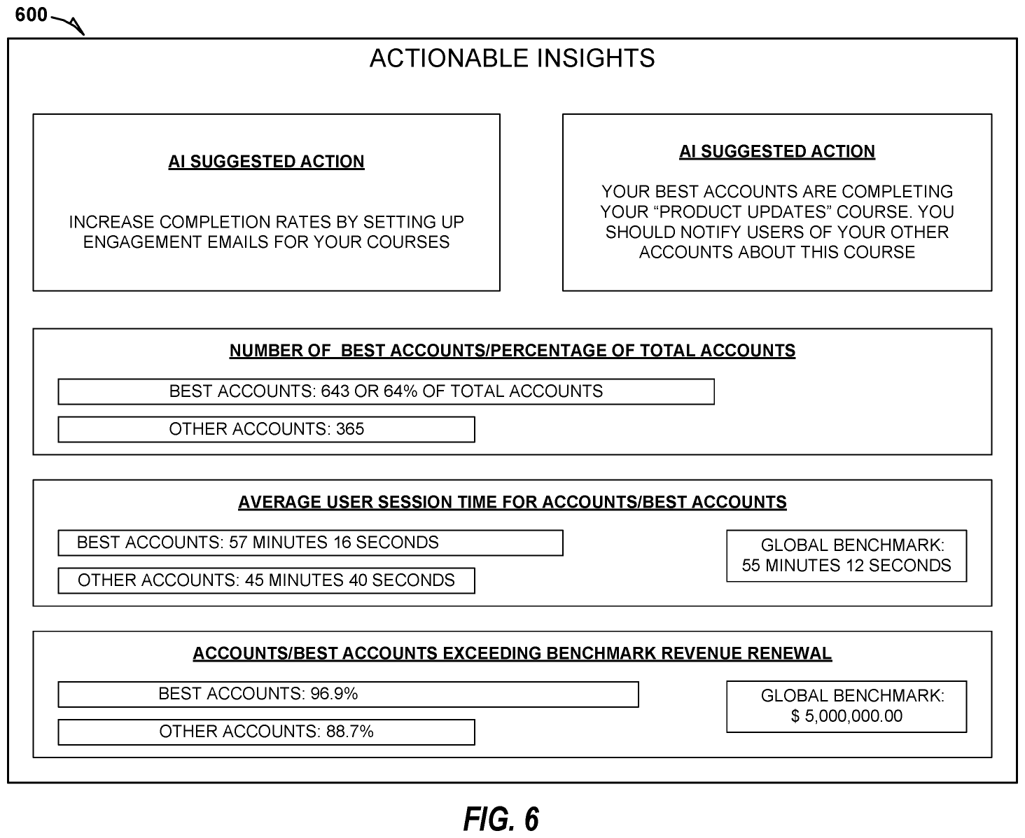

FIG. 6 a block diagram of a GUI for examining insights and/or suggestions, from an AI, for improving the training programs (e.g., the actionable insights page 600), according to implementations of the disclosure.

The actionable insights page 600 may include interface elements for viewing and/or requesting insights and/or suggestions, from an AI, for improving a user's (e.g., program manager/curriculum developer's) training programs. For example, based on the user's definition of their best accounts (e.g., via the best accounts page 500 of FIG. 5 as described above), the insights page 600 may display suggested actions based on a machine learning (ML) model that may compare the respective performance (e.g., with regard to a benchmark metric) of the best accounts and the other accounts and suggest improvements to the training programs based on the comparison or best practice. For example, in FIG. 6, the AI has discovered that the best accounts engage more often than the other accounts with the user's “Product Updates” course and it provides an “AI suggested action” to bring attention to this course and an “AI suggested action” to bring attention to all of the user's courses by configuring engagement emails for the courses.

In some implementations, the actionable insights page 600 may show the user correlation-based insights extracted automatically. For example, suppose a given training program's completion rate is lower than other similar programs included in the calculation of the global benchmark, then the user (e.g., the training program manager) may automatically be shown correlation insights, whenever available, such as “your courses have 8 lessons on average vs. 3-5 lessons for courses in similar training programs at the user's best accounts”, or “your users are enrolled into 1 course vs 3 enrolled courses for users for similar training programs”. As noted above, the user may simply dismiss the insights/suggestions.

In some implementations, the actionable insights page 600 may include an interface element for allowing the user to provide quick feedback on the insights and/or the suggestions provided by the AI. For example, a graphical thumbs up/down selection mechanism may be used to receive user feedback regarding whether the user finds the insight/suggestion helpful. This user feedback may be captured by the system (e.g., system 100 of FIG. 1), and may be used by a machine learning algorithm, for determining which insights have been regarded as useful by the training program managers and/or curriculum developers.

The actionable insights page 600 may also include interface elements for comparing the key training program metrics of the user's best accounts versus those of the user's other accounts. For example, the actionable insights page 600 may include interface elements for comparing the “number of best accounts vs. the number of total accounts” or for comparing the key training program metrics of “average user session time” and “accounts exceeding benchmark revenue renewal” in order to compare the revenue renewal rate of the user's best accounts against those of the user's other accounts. The user may also compare the metrics of both best accounts and other accounts against the “global benchmark” value for selected benchmark metrics.

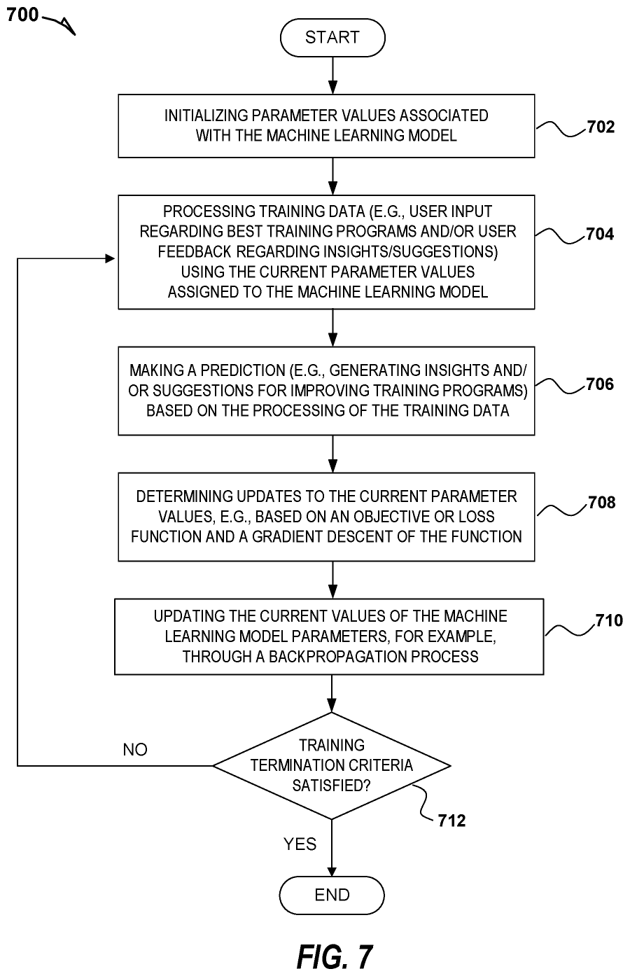

FIG. 7 shows a flow diagram of an example method 700 illustrating how a machine learning (ML) model may be trained to generate insights and/or suggestions for improving the training programs, according to implementations of the present disclosure.

The training process (e.g., method 700) may be performed by a system of one or more computers. At operation 702, the system may initialize the operating parameters of the machine learning model (e.g., weights associated with various layers of an artificial neural network used to implement the machine learning model). For example, the system may initialize the parameters based on samples from one or more probability distributions or parameter values associated with a similar machine learning model (e.g., associated with improving similar programs).

At operation 704, the system may process training data, such as, user suggestions regarding best training program accounts and/or other training data, such as, user feedback regarding previously provided insights/suggestions for improving training programs, using the current parameter values assigned to the machine learning model.

At operation 706, the system may make a prediction (e.g., generating insights and/or suggestions for improving the training programs) based on the processing of the training data.

At operation 708, the system may determine updates to the current parameter values associated with the machine learning model, e.g., based on an objective or loss function and a gradient descent of the function. As described herein, the objective or loss function may be designed to measure a difference between the prediction and a ground truth. The objective function may be implemented using, for example, mean squared errors, L1 norm, etc. associated with the prediction and/or the ground truth.

At operation 710, the system may update the current values of the machine learning model parameters, for example, by backpropagating the gradient descent of the loss function through the artificial neural network. The learning process may be an iterative process, and may include a forward propagation process to predict an output (e.g., prediction) based on the machine learning model and the input data fed into the machine learning model, and a backpropagation process to adjust parameters of the machine learning model based on a gradience descent associated with a calculated difference between the desired output (e.g., ground truth) and the predicted output.

At operation 712, the system may determine whether one or more training termination criteria are satisfied. For example, the system may determine that the training termination criteria are satisfied if the system has completed a pre-determined number of training iterations, or if the change in the value of the loss function between two training iterations falls below a predetermined threshold. If the determination at 712 is that the training termination criteria are not satisfied, the system may return to 704. If the determination at 712 is that the training termination criteria are satisfied, the system may end the training process 700.

After training, the system (e.g., a replica of the system) may receive new data inputs (e.g., new user feedback regarding insights/suggestions provided by the ML model) associated with the improvement of the training programs and determine, based on the trained machine learning model, an estimated output in the form of a predicted outcome for the tasks (e.g., generating insights and/or suggestions for improving the training programs).

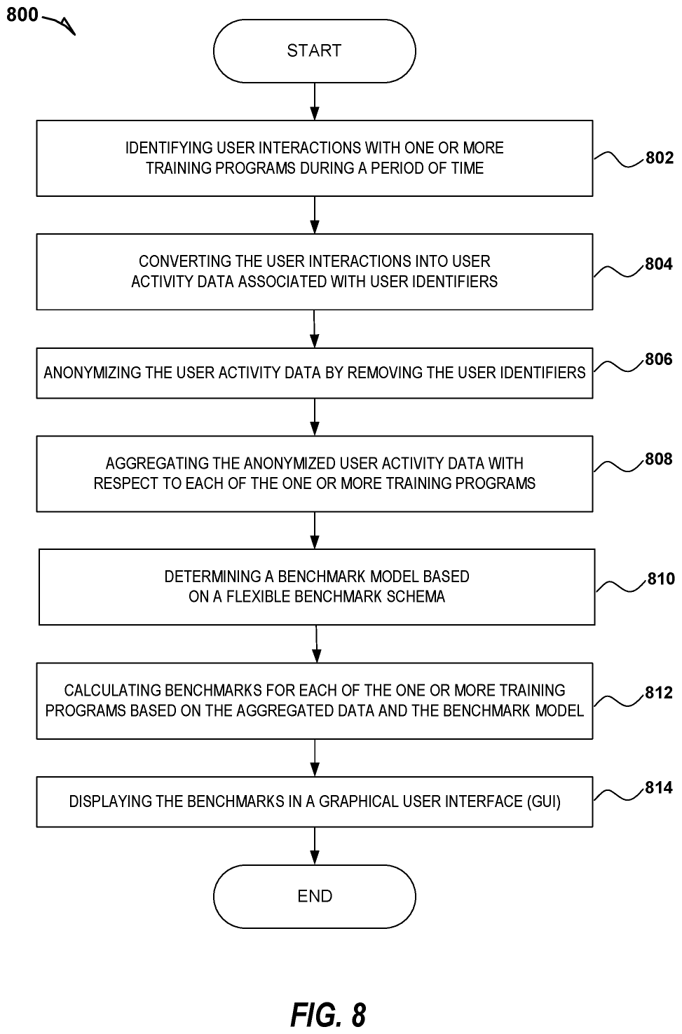

FIG. 8 shows a flow diagram of a method 800 for implementing a flexible benchmark application for evaluating training programs, according to implementations of the disclosure.

The method 800 may start and then continue to operation 802 identifying user interactions with one or more of the training programs during a period of time. As noted above with respect to FIG. 1, the training programs 114 may include discrete and/or self-contained product training materials for one or more products of the business. Furthermore, the training programs 114 may include timestamps aligned with their content, thus enabling the determination of precise start and end times of each session of training by a user so that the resulting user activity data may be determined to be within the period of time (e.g., the last month) for which benchmarks are being calculated. Still further, the identification of user interactions with the training programs 114 stored in information system 110 may include verification of the user's identifier and credentials (e.g., user login handle and password) to check out a training program 114 and presentations of the training program 114 to the user, where the presentations may include a start, a pause, and an end of a session of the training program 114 by a media player on the GUI 112.

At operation 804, converting the user interactions into user activity data with user identifiers (e.g., in the form of user activity data objects as described more fully above with respect to FIG. 2). The user activity data may then be recorded (e.g., stored in storage device 104 or stored in information system 110 of FIG. 1). As noted above, in one implementation, the user activity data object may be defined according to a data structure format for recording the user activities during training sessions or user interactions with training programs. For example, as noted above, the data structure may include a user identifier that is associated with a target user, an employer identifier that is associated with an end user company that employs the target user, a training academy identifier that is associated with the training provider, and/or real-time user activity data captured during the training.

At operation 806, anonymizing the user activity data by removing the user identifiers. Any user identification information and/or business identification information may be removed before using the user activity data to calculate benchmark scores of different training programs in order to maintain the confidentiality and privacy of different businesses and users. For example, one way to anonymize the user activity data is to replace the username and training program identifiers with hashed identifiers which may be globally unique identifiers, to preserve the privacy of the user and the training program.

At operation 808, aggregating the anonymized user activity data with respect to each of the one or more training programs. As noted above with respect to FIG. 1, the aggregated data may be used for the calculation of the statistics indicating the effectiveness of each of the training programs (e.g., benchmarking). After the aggregation, the anonymized user activity data may be associated with a corresponding training program.

At operation 810, determining a benchmark model based on a flexible benchmark schema. As noted above with respect to FIG. 1, the benchmark schema may include a variety of benchmark metrics, such as average completion rate of program users, enrollments per program user and session time per program user, that may be selected to form the benchmark model for evaluating the training program. Also as noted above, in one implementation, the metrics included in the benchmark schema 118 may be defined by a user (see FIG. 4 above) so that a more flexible benchmarking of the training programs 114 may be possible.

At operation 812, calculating benchmarks for each of the one or more training programs based on the aggregated anonymized user activity data and the benchmark model. The training programs may be evaluated based on the benchmark metrics selected from the flexible benchmark schema to generate the benchmark model. In some implementations, the benchmark calculation may include applying “benchmark program criteria”, generating a large number of “candidate benchmarks”, applying “benchmark selection” criteria, performing “aggregation by criteria” and calculating “benchmark metrics and trends” as described above.

At operation 814, displaying the calculated benchmark values in a graphical user interface (GUI) such as GUI 112 of interface device 106 of FIG. 1. As noted above, the calculated benchmark metrics may be loaded into production databases so that they may be made available on-demand to the users (e.g., a training program manager or a curriculum developer using the benchmark application 108 of FIG. 1). When new benchmark metrics become available (e.g., from a subsequent period of time) they may be displayed in the GUI 112, so that the benchmark application 108 may smoothly transition from an older benchmark metrics dataset to a newer benchmark metrics dataset. The method 800 may then end.

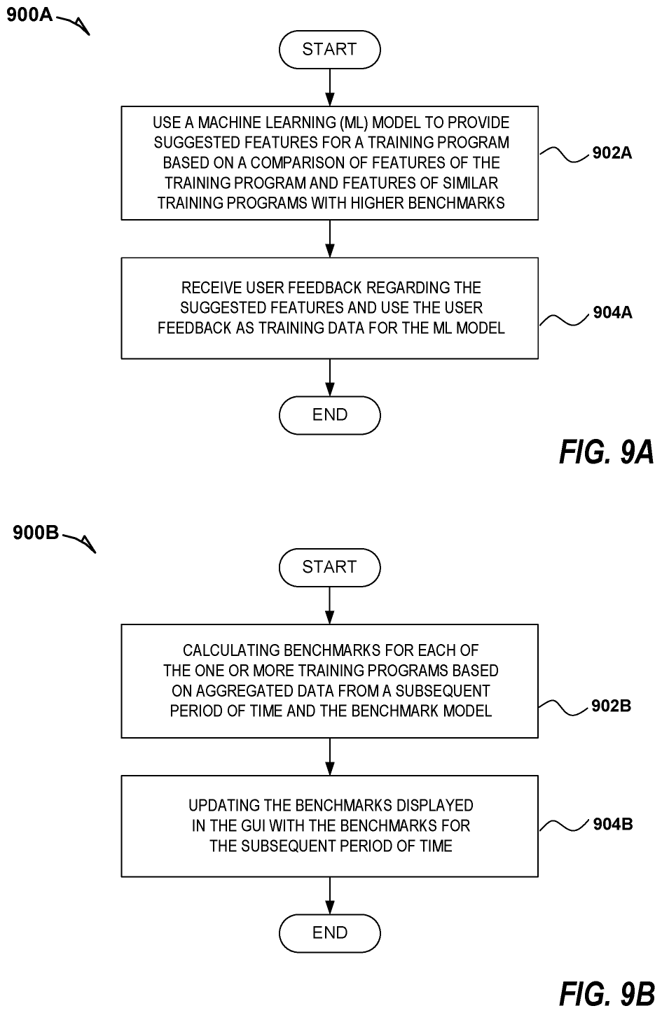

FIG. 9A shows a flow diagram of a method 900A for using a machine learning (ML) model to provide suggested features for a training program based on a comparison of training program features, according to implementations of the disclosure.

The method 900A may start and then continue to operation 902A a machine learning (ML) model to provide suggested features for a training program based on a comparison of features of the training program and features of similar training programs with higher benchmarks. As noted above with regard to the actionable insights page 600 of FIG. 6, the user's definition of their best accounts (e.g., via the best accounts page 500 of FIG. 5 as described above) may be the basis for a machine learning (ML) model to compare the respective performance (e.g., with regard to a benchmark metric) of the best accounts and the other accounts and suggest improvements to the training programs based on the comparison.

At operation 904B, receiving user feedback regarding the suggested features and using the user feedback as training data for the ML model. As described above, the actionable insights page 600 may include an interface element for allowing the user to provide quick feedback on the insights and/or the suggestions provided by the ML model. This user feedback may be captured by the system (e.g., system 100 of FIG. 1), and may be used to train a machine learning model (as described above with respect to FIG. 7), based on which insights have been regarded as useful by the training program managers and/or curriculum developers. The method 900A may then end.

FIG. 9B shows a flow diagram of a method for updating values for the benchmarks displayed in the GUI based on additional aggregated data associated with user interactions with a training program, according to implementations of the disclosure.

The method 900B may start and then continue to operation 902B calculating benchmarks for each of the one or more training programs based on aggregated data from a subsequent period of time and the benchmark model. As noted above, updates to the benchmark scores of the training programs may be performed on a periodic basis, for example monthly, after the full month of user activity data associated with the training program is available. As noted above, the update to the benchmark scores of the training programs may include a full recalculation of the benchmark scores.

At operation 904B, updating the benchmarks displayed in the GUI with the benchmarks for the subsequent period of time. As described above, the calculated benchmark metrics may be loaded into production databases so that they may be made available on-demand to the users (e.g., a training program manager or a curriculum developer using the benchmark application 108 of FIG. 1). When new benchmark metrics become available (e.g., from a subsequent period of time) they may be displayed in the GUI 112, so that the benchmark application 108 may smoothly transition from an older benchmark metrics dataset to a newer benchmark metrics dataset. The method 900B may then end.

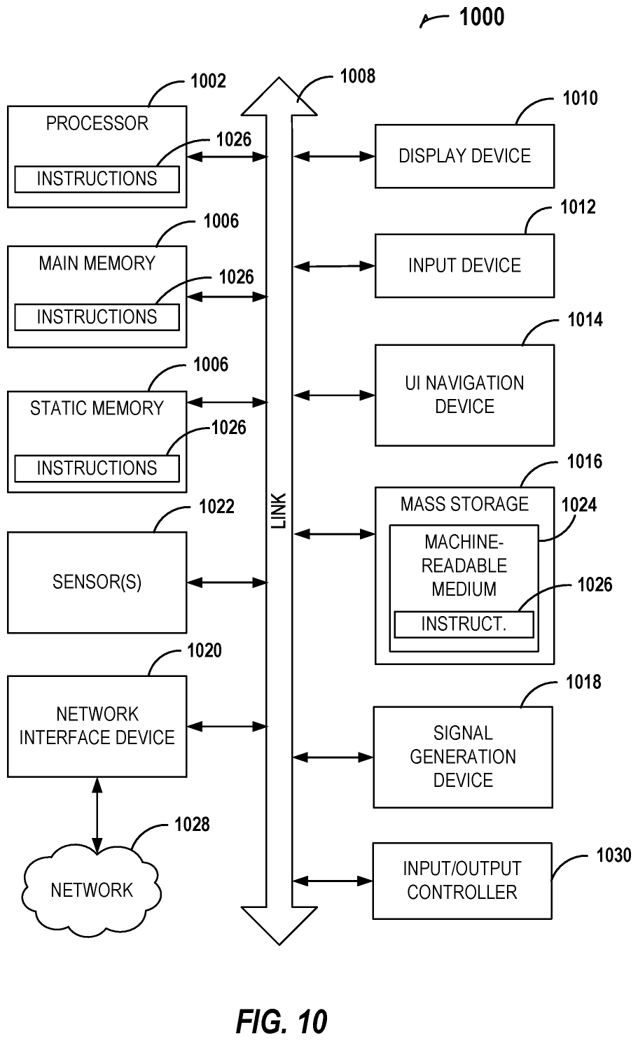

FIG. 10 is a block diagram illustrating a machine in the example form of a computer system 1000, within which a set or sequence of instructions may be executed to cause the machine to perform any one of the methodologies discussed herein.

In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein (e.g., method 700 of FIG. 7, method 800 of FIG. 8, method 900A of FIG. 9A, and method 900B of FIG. 9B).

Example computer system 1000 includes at least one processor 1002 (e.g., a central processing unit (CPU), a graphics processing unit (GPU) or both, processor cores, compute nodes, etc.), a main memory 1004 and a static memory 1006, which communicate with each other via a link 1008 (e.g., bus). The computer system 1000 may further include a video display unit 1010, an alphanumeric input device 1012 (e.g., a keyboard), and a user interface (UI) navigation device 1014 (e.g., a mouse). In one embodiment, the video display unit 1010, input device 1012 and UI navigation device 1014 are incorporated into a touch screen display. The computer system 1000 may additionally include a storage device 1016 (e.g., a drive unit), a signal generation device 1018 (e.g., a speaker), a network interface device 1020, and one or more sensors 1022, such as a global positioning system (GPS) sensor, accelerometer, gyrometer, magnetometer, or other such sensor.

The storage device 1016 includes a machine-readable medium 1024 on which is stored one or more sets of data structures and instructions 1026 (e.g., software) embodying or utilized by any one or more of the methodologies or functions described herein. The instructions 1026 may also reside, completely or at least partially, within the main memory 1004, static memory 1006, and/or within the processor 1002 during execution thereof by the computer system 1000, with main memory 1004, static memory 1006, and the processor 1002 comprising machine-readable media.

While the machine-readable medium 1024 is illustrated in an example embodiment to be a single medium, the term “machine-readable medium” may include a single medium or multiple media (e.g., a centralized or distributed database, and/or associated caches and servers) that store the one or more instructions 1026. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include volatile or non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1026 may further be transmitted or received over a communications network 1028 using a transmission medium via the network interface device 1020 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 16G LTE/LTE-A or WiMAX networks). The term “transmission medium” shall be taken to include any intangible medium that is capable of storing, encoding, or carrying instructions for execution by the machine, and includes digital or analog signals or other intangible medium to facilitate communication of such software.

Example computer system 1000 may also include an input/output controller 1030 to receive input and output requests from at least one central processor 1002, and then send device-specific control signals to the device they control. The input/output controller 1030 may free at least one central processor 1002 from having to deal with the details of controlling each separate kind of device.

The term “computer-readable storage medium” used herein may include any tangible medium that is capable of storing or encoding a set of instructions for execution by a computer that cause the computer to perform any one or more of the methods described herein. The term “computer-readable storage medium” used herein may include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure. In addition, unless specifically stated otherwise, discussions utilizing terms such as “analyzing,” “determining,” “enabling,” “identifying,” “modifying” or the like, refer to the actions and processes of a computer system, or similar electronic computing device, that manipulates and transforms data represented as physical (e.g., electronic) quantities within the computer system's registers and memories into other data represented as physical quantities within the computer system memories or other such information storage, transmission or display devices.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

1. A system implemented by one or more computers to flexibly benchmark training programs, the one or more computers comprising:
a storage device; and
a processing device, communicatively connected to the storage device, to:
identify user interactions with one or more of the training programs during a period of time;
convert the user interactions into user activity data associated with user identifiers;
anonymize the user activity data by removing the user identifiers;
aggregate the anonymized user activity data with respect to each of the one or more training programs;
determine a benchmark model based on a flexible benchmark schema;
calculate benchmarks for each of the one or more training programs based on the aggregated user activity data and the benchmark model; and
present the benchmarks in a graphical user interface (GUI) on a display.

2. The system of claim 1, wherein the processing device is further to aggregate the anonymized user activity data with respect to each of the one or more training programs based on the respective training program satisfying specified benchmark program criteria.

3. The system of claim 2, wherein the specified benchmark program criteria comprise at least one of a number of users of the program during the period of time or an age of the program at the end of the period of time.

4. The system of claim 1, wherein the flexible benchmark schema comprises selectable metrics for evaluating the training programs.

5. The system of claim 4, wherein the selectable metrics for evaluating the training programs comprise at least one of an average completion rate of program users, enrollments per program user, or a session time per program user.

6. The system of claim 4, wherein to calculate benchmarks for each of the one or more training programs based on the aggregated user activity data and the benchmark model the processing device is further to:
determine a median of values for a selected metric for evaluating the training programs; and
remove any aggregated data from interactions with a training program with a value for the selected metric that is greater than a threshold value from the median of the values for the selected metric for the training programs.

7. The system of claim 1, wherein the processing device is further to:
calculate benchmarks for each of the one or more training programs based on aggregated user activity data from a subsequent period of time and the benchmark model; and
update the benchmarks displayed in the GUI with the benchmarks for the subsequent period of time.

8. The system of claim 1, wherein the processing device is further to convert the user interactions into user activity data objects associated with user identifiers in real time while the user interacts with the training program.

9. The system of claim 8, wherein the user activity data objects comprise:
a user component including values for at least one of a user's identifier, a user's sign-in credentials, a user's employer, or a user's role with the employer;
a user activity component including values for at least one of a lesson identifier, timestamps for enrollment and completion of the lesson, or a duration of the lesson;
a business and program component including values for at least one of an employer account, an industry of the employer, a use case of the training program for the employer, or a target audience of the employer; and
a lesson component including values for at least one of a lesson identifier, a lesson content type, a lesson modality, or a lesson enrollment requirement.

10. The system of claim 1, wherein the processing device is further to:
use a machine learning (ML) model to provide suggested actionable insights for a training program based on a comparison of features of the training program and features of similar training programs with higher benchmarks; and
receive user feedback regarding the suggested actionable insights and use the user feedback as training data for the ML model.

11. A method implemented by one or more computers to flexibly benchmark training programs, the method comprising:
identifying user interactions with one or more of the training programs during a period of time;
converting the user interactions into user activity data associated with user identifiers;
anonymizing the user activity data by removing the user identifiers;
aggregating the anonymized user activity data with respect to each of the one or more training programs;
determining a benchmark model based on a flexible benchmark schema;
calculating benchmarks for each of the one or more training programs based on the aggregated user activity data and the benchmark model; and
displaying the benchmarks in a graphical user interface (GUI).

12. The method of claim 11, further comprising aggregating the anonymized user activity data with respect to each of the one or more training programs based on the respective training program satisfying specified benchmark program criteria.

13. The method of claim 12, wherein the specified benchmark program criteria comprise at least one of a number of users of the program during the period of time or an age of the program at the end of the period of time.

14. The method of claim 11, wherein the flexible benchmark schema comprises selectable metrics for evaluating the training programs.

15. The method of claim 14, wherein the selectable metrics for evaluating the training programs comprise at least one of an average completion rate of program users, enrollments per program user, or a session time per program user.

16. The method of claim 14, wherein to calculate benchmarks for each of the one or more training programs based on the aggregated user activity data and the benchmark model the method further comprises:
determining a median of values for a selected metric for evaluating the training programs; and
removing any aggregated data from interactions with a training program with a value for the selected metric that is greater than a threshold value from the median of the values for the selected metric for the training programs.

17. The method of claim 11, further comprising:
calculating benchmarks for each of the one or more training programs based on aggregated user activity data from a subsequent period of time and the benchmark model; and
updating the benchmarks displayed in the GUI with the benchmarks for the subsequent period of time.

18. The method of claim 11, further comprising converting the user interactions into user activity data objects associated with user identifiers in real time while the user interacts with the training program.

19. The method of claim 18, wherein the user activity data objects comprise:
a user component including values for at least one of a user's identifier, a user's sign-in credentials, a user's employer, or a user's role with the employer;
a user activity component including values for at least one of a lesson identifier, timestamps for enrollment and completion of the lesson, or a duration of the lesson;
a business and program component including values for at least one of an employer account, an industry of the employer, a use case of the training program for the employer, or a target audience of the employer; and
a lesson component including values for at least one of a lesson identifier, a lesson content type, a lesson modality, or a lesson enrollment requirement.

20. The method of claim 11, further comprising:
using a machine learning (ML) model to provide suggested actionable insights for a training program based on a comparison of features of the training program and features of similar training programs with higher benchmarks; and
receiving user feedback regarding the suggested actionable insights and using the user feedback as training data for the ML model.
